(19) United States
(12) Patent Application Publication
(10) Pub. No.: US 2017/0319999 A1
(43) Pub. Date: Nov. 9, 2017

(54) Cooling Tower Tray

(71) Applicants: Daniel Hirth, Houston, TX (US); Antonio J. Hirth, Houston, TX (US); Leo A. Hirth, Pasadena, TX (US)

(72) Inventors: Daniel Hirth, Houston, TX (US); Antonio J. Hirth, Houston, TX (US); Leo A. Hirth, Pasadena, TX (US)

(21) Appl. No.: 15/585,314

(22) Filed: May 3, 2017

Related U.S. Application Data
(60) Provisional application No. 62/331,701, filed on May 4, 2016.

(51) Int. Cl. B01D 46/00; B01D 46/10; F28F 19/01; F28F 25/10

(52) U.S. Cl. CPC B01D 46/0005; F28F 25/10; B01D 46/10; F28F 19/01; B01D 2279/50

(57) ABSTRACT

A cooling tower tray. The cooling tower tray has a base with a first end, second end, and opposing sides. Multiple sidewalls attached to the base and extending upwards from the first end, second end, and opposing sides. The sidewalls and base form an interior volume with an open upper end. One or more of the sidewalls are a perforated sidewall with multiple apertures. A filter rests within the interior volume. Some embodiments have a handle attached to a sidewall.

### CROSS REFERENCE TO RELATED APPLICATIONS

This application claims the benefit of U.S. Provisional Application No. 62/331,701 filed on May 4, 2016. The above identified patent application is herein incorporated by reference in its entirety to provide continuity of disclosure.

### BACKGROUND OF THE INVENTION

The present invention relates to cooling tower trays. Specifically, a cooling tower tray that would minimize upkeep of the Heating, Ventilation, and Air Conditioning (HVAC) system and maximize the HVAC's operational life. HVAC systems are present in most American buildings in some form. Ranging from industrial to individual window units, these systems have become ubiquitous over the past century. Regular maintenance and repair is necessary for these systems, especially the larger more complex systems that operate for longer periods and have larger outputs than the simpler residential models.

Some of the industrial HVAC systems use cooling towers that house chillers, water pumps, tubes, and other mechanisms necessary for their normal operation. These towers have many vents and oftentimes gather dirt, dust, debris, and other unwanted detritus. These materials cause damage to the components housed within the cooling tower and thus increase the frequency and cost of maintenance. The damage caused can also cause additional damage independently of the detritus if not regularly attended to. Therefore, it is desirable for there to be a defense against the unwanted detritus of the world.

### SUMMARY OF THE INVENTION

In view of the foregoing disadvantages inherent in the known types of cooling tower trays now present in the prior art, the present invention provides a cooling tower tray wherein the same can be utilized for providing convenience for the user when installing and maintaining a heating, ventilation, and air conditioning system. The present system comprises a base with a first end, second end, and opposing sides; a plurality of sidewalls extending upwards from the first end, the second end, and the opposing sides forming an interior volume with an open upper end; the plurality of sidewalls further comprising a perforated sidewall wherein the perforated sidewall further comprises a plurality of apertures; a filter configured to fit within the interior volume.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of a first embodiment of the cooling tower tray.

FIG. 2 shows a perspective view of a first embodiment of the cooling tower tray with the filter raised out of the tray.

### DETAILED DESCRIPTION OF THE INVENTION

Reference is made herein to the attached drawings. Like reference numerals are used throughout the drawings to depict like or similar elements of the cooling tower tray. The figures are intended for representative purposes only and should not be considered to be limiting in any respect. Unless specifically limited to a single unit, “a” is intended to be equivalent to “one or more” throughout the present disclosure.

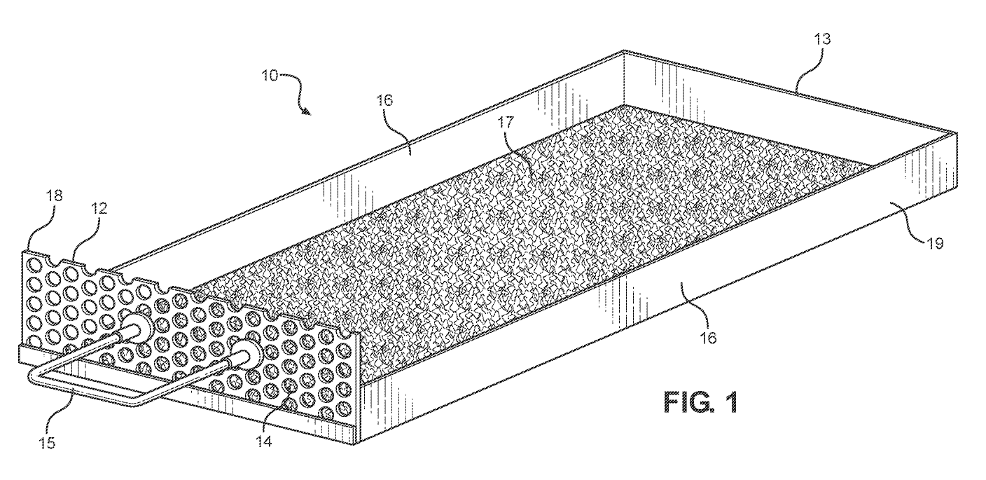

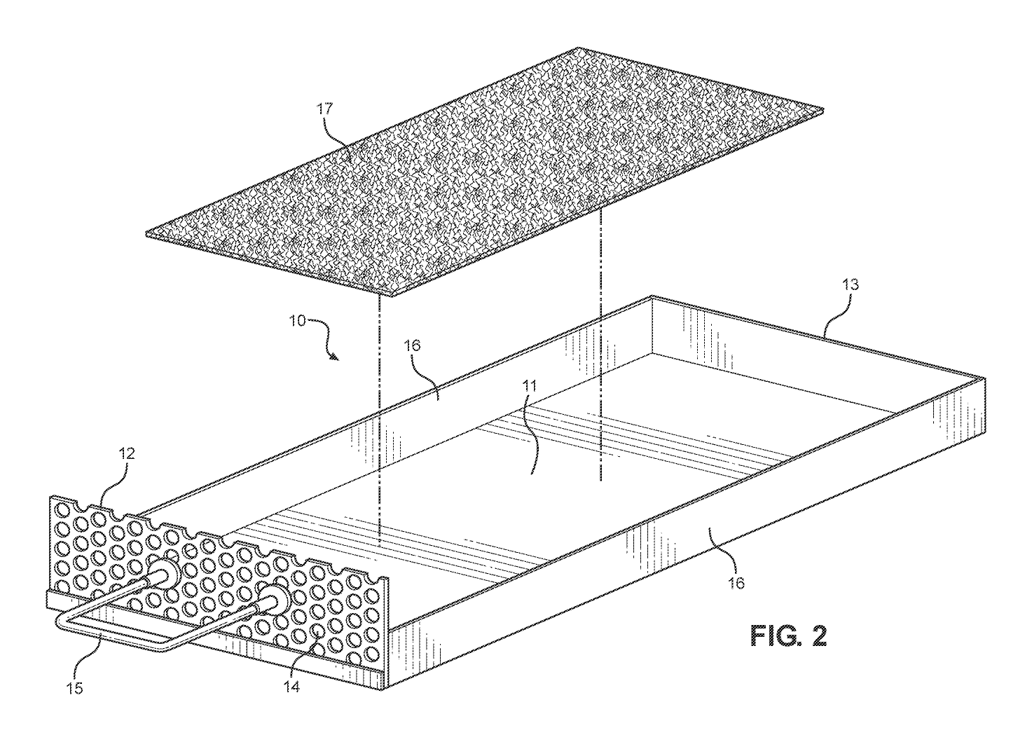

Referring now to FIGS. 1 and 2, there is shown a perspective view of an embodiment of the cooling tower tray, and a perspective view of an embodiment of the cooling tower tray with the filter raised out of the tray, respectively. The cooling tower tray 10 has a base 11 having a perimeter with a first end 12, a second end 13, and opposing sides 16. A sidewall 19 extends upwards from the perimeter of the base 11 to form an interior volume with an open upper end. One or more of the sidewalls 19 include a perforated sidewall 18 with a plurality apertures 14. In the illustrated embodiment, the perforated sidewall 18 of the cooling tower tray 10 further comprises a handle 15. The handle 15 extends outward from the first end 12 so as to provide a gripping region for a user to handle. In the illustrated embodiment, the shape of the cooling tower tray 10 is rectangular however, in other embodiments the shapes are varied and include multiple polyhedral variations as well as other shapes.

A filter 17 rests within the interior volume and atop the base 11. In the illustrated embodiment, the base 11 is made of a solid stainless steel and the first end 12 is opposing the second end 13. In the illustrated embodiment, the base 11 does not oxidize, degrade, or diminish in capacity in the presence of water and/or humidity. In other embodiments, the base 11 is perforated, has multiple apertures 14, and is made of other materials known to those of ordinary skill in the art.

The sidewalls 19 extend upwards from the first end 12, second end 13, and opposing sides 16. In the illustrated embodiment, the sidewalls 19 with the exception of the perforated sidewall 18, are made of a solid stainless steel and extend upwards from the base 11. In the illustrated embodiment, the sidewalls 19 and base 11 are stamped out from a single sheet of stainless steel with adjoining sidewalls affixed to one another by welding. In the illustrated embodiment, the perforated sidewall 18 has a greater height dimension than the non-perforated sidewalls 19 when measured from the base 11 to a terminating end of the each of the sidewalls. In other embodiments, the sidewalls 19 are made of a different material from the base 11 such as aluminum or plastic and are affixed to the base 11 through other methods such as welding or adhesive, and have different dimensions.

In the illustrated embodiment, the perforated sidewall 18 is affixed to the adjoining sidewalls by welding and the perforated sidewall has evenly spaced apertures 14 punched throughout. These apertures 14 allow air to flow in and out of the cooling tower tray 10 and over the filter 17. In other embodiments, the apertures 14 are not evenly spaced. In the illustrated embodiment, the base 11 and sidewalls 19 were stamped out from a single sheet of stainless steel after the apertures 14 were punched out of the relevant section of the single sheet of stainless steel. In some embodiments, the sidewalls 19 are affixed to adjoining sidewalls. In other embodiments, the perforated sidewall 18 is made of other materials such as plastic or aluminum and attached by other methods such as welding or adhesive.

In the illustrated embodiments, the filter 17 is made of interlace polyester fibers forming a porous surface and is dimensioned to fill the entirety of interior volume of the cooling tower tray 10. The filter 17 rests upon the base 11 held via frictional engagement by the sidewalls 19. In the illustrated embodiment, the filter 17 is washable and replaceable. In other embodiments, the filter 17 is made of other material known to persons of ordinary skill in the art. In some embodiments, the filter 17 is dimensioned differently and is affixed to the base or sidewalls.

In the illustrated embodiment, there is a handle 15 made of the same material as the perforated sidewall 18 to which the handle 15 is affixed. In the illustrated embodiment, the method of affixture is a receiver cap affixed to the perforated sidewall and adhesive binding the handle 15 therein. In other embodiments, the handle 15 is affixed by welding and other methods known to persons of ordinary skill in the art.

In use, the cooling tower tray 10 is inserted into a heating, ventilation, and air conditioning system. The cooling tower tray 10 allows the free flow of air into and out of the system while simultaneously capturing large detritus outside of the system and finer detritus within the filter 17. During maintenance, a technician may simply remove the cooling tower tray 10, remove the filter 17, rinse the filter 17 and interior volume with water, return the filter 17 into the interior volume, and return the cooling tower tray 10 to the system. The filter 17 can also be disposable and in that case the filter 17 would be replaced with a new filter 17 during maintenance.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A cooling tower tray, comprising:
one or more sidewalls extending from a base along a perimeter, defining an interior volume;
the one or more sidewalls comprising a perforated sidewall, the perforated sidewall including a plurality of apertures, each aperture configured to allow fluid to pass therethrough;
a filter dimensioned to correspond to a dimension of the base, the filter selectively removable therefrom.

2) The cooling tower tray of claim 1, wherein:
each of the one or more sidewalls of the plurality of sidewalls is affixed to the adjoining sidewalls.

3) The cooling tower tray of claim 1, further comprising:
a handle affixed to at least one sidewall from the plurality of sidewalls.

4) The cooling tower tray of claim 4, wherein:
the handle is affixed to the perforated sidewall.

5) The cooling tower tray of claim 1, wherein:
the perforated sidewall extends upward for a longer distance than the sidewall.

6) The cooling tower tray of claim 1, wherein:
the base further comprises a plurality of apertures.

7) The cooling tower tray of claim 1, wherein:
the filter is made of a synthetic, porous, and durable material.
